(19) United States
(12) Patent Application Publication
(10) Pub. No.: US 2004/0037298 A1
(43) Pub. Date: Feb. 26, 2004

(54) Device for optimizing peripheral devices in a telecommunication network

(76) Inventors: Herwig Eltschka, Starnberg (DE); Norbert Lobig, Darmstadt (DE)

Correspondence Address: Morrison & Foerster, Suite 300, 1650 Tysons Boulevard, McLean, VA, 22102, US

(21) Appl. No.: 10/221,270

(22) PCT Filed: May 17, 2001
(86) PCT No.: PCT/DE01/01892

(30) Foreign Application Priority Data
May 29, 2000 (DE) 100 26 636.3

(51) Int. Cl. H04L 12/66; H04L 12/28

(52) U.S. Cl. 370/401; 370/219

(57) ABSTRACT

The invention relates to a device for processing connections which are established by a switching system and associated with a plurality of peripheral devices. Each of the peripheral devices (LTG) is associated with interfaces for devices which communicate with devices both inside and outside the system. The invention is characterized in that each of the peripheral devices has its own logical interface with the message distribution system inside and outside the switching system. The invention is further characterized in that a process control system which is common to the plurality of peripheral devices is also provided. Said process control system processes the tasks assigned to each of the peripheral devices contained in said plurality in exactly the same way as individual process control devices do for each peripheral device.

The invention relates to a device according to the preamble of claim 1.

The structure of a switching node is described in the European patent application EP 99123208.3. For reasons of fail-safe reliability, the central components of the switching system are designed to be redundant (i.e., doubled). The peripheral devices cannot be redundant or possess redundancy in the case of increased failure requirements (e.g., rescuing stable connections beyond the failure of a peripheral device).

The performance capacity of the peripheral devices is determined by the performance of the processors of the peripheral device, the size of the pool of conference points, tone generators and DTMF receivers that can be used according to switching technology, the capacity of the protocol terminating device (HDLC ports and message through-put), the number of terminated lines per peripheral device, the message interface for signaling messages (DDS1/ISUP) and packet data on the D channel, the internal interface to the message distribution system, as well as by the size of the data memory.

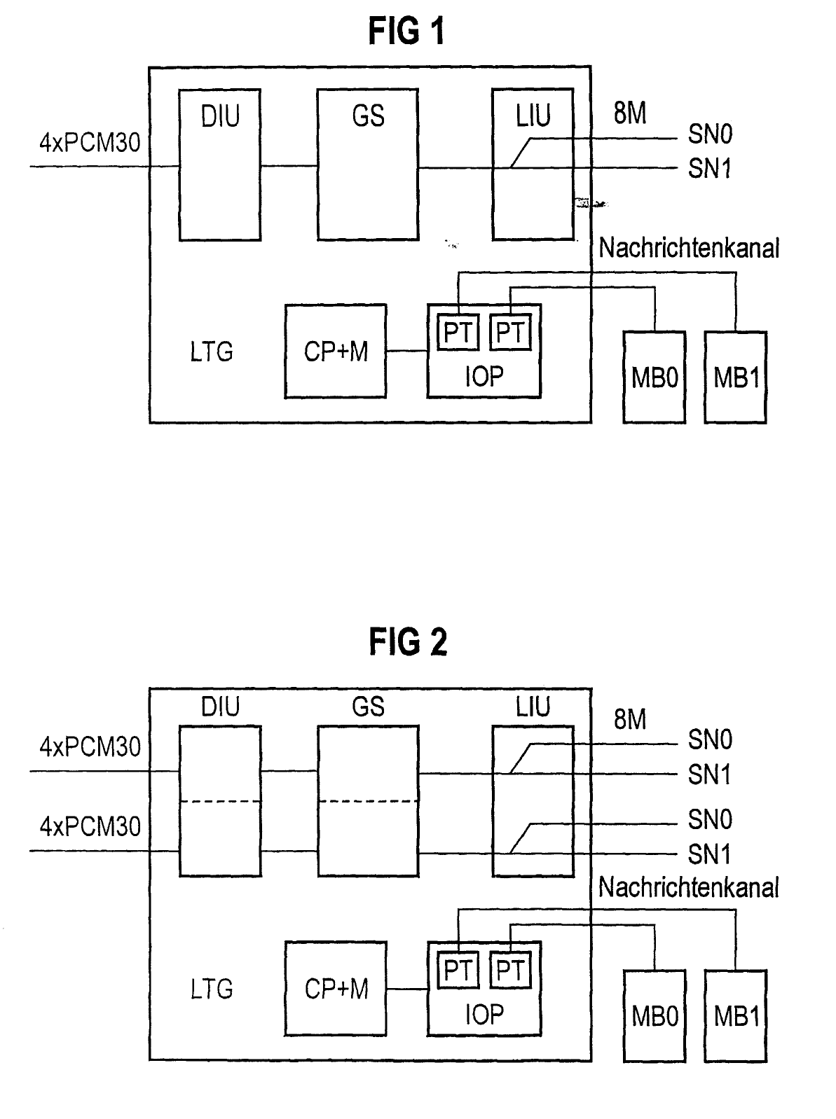

The classic peripheral device LTG according to the state of the art (see FIG. 1) consists of hardware devices for terminating the connections to the peripherals DIU and to the central coupling network SN0, SN1, an internal coupling network GS, pools of switching technology functions LTU (tone generators, etc.), a central process core consisting of a processor and a memory (CP+M), and access (IOP) to the central computer platform CP. It precisely terminates the connection lines for which it has the responsibility of handling the switching technology processing. For reasons of fail-safe reliability, access to the central computer platform CP is carried out redundantly, in the form of an active message channel and a message channel that is available as a substitute, which channels are terminated in separate terminations (PT). Usually, there are peripheral devices for terminating n PCM segments (e.g., n=4 PCM30 segments for 120 connection lines). The development of the processors towards greater capacity makes it possible to significantly increase the number of segments that can be terminated per peripheral device.

Without adapting the software of the switching center, the peripheral device can only process the maximum number of connectable switching segments as determined by the current physical termination. Optimization by means of a simple increase in the number of PCM segments that can be processed per peripheral device has repercussions for all of the devices of the switching system, up to and including the input and output operations. Because of the great amount of effort and expense needed for changes that would result, this is a structurally clean but inefficient method of procedure.

This results in the following technical problem:

How can the number of subscriber and/or trunk connections in a hardware platform for peripheral devices that are used to fulfill switching technology tasks be increased by means of optimal utilization of the capacity of the existing processor and memory in such a way that the previous peripheral devices, in particular, continue to be maintained in the structure characterized by the previous peripheral equipment limitations? In this connection, possible effort and expense for software changes within the switching system and outside of the switching system (e.g., support tools of the manufacturer and the network operator) should be minimized, and the internal and external interfaces to other devices of the switching system and outside of the switching system should not be affected, thereby avoiding to a great extent effort and expense to change software, firmware and hardware. Finally, compatibility with the old environment should be a given, in other words it should be possible to utilize the hardware platform for peripheral devices within the switching system with older versions of the switching center software that do not support optimized use of the hardware platform, and the hardware platform should be compatible with them.

In the state of the art, peripheral devices according to FIG. 1 have always been related to hardware. They are the units that physically terminate connection lines, connection lines to subscriber connection concentrators and subscriber connection lines. They are identified in the software of the switching center through this termination.

If only signaling protocols are now supposed to be closed or converted, this is done on devices without any physical line reference, which devices do not themselves terminate the subscribers and/or lines served by them to prior concentrators and connection. These are, for example, peripheral devices on which a processor operates several peripheral devices implemented in software. An example of such an implementation is described in the European patent application EP 99123208.3.

In the state of the art, however, the peripheral units, which physically terminate connection lines, connection lines to subscriber connection concentrators and subscriber connection lines, form a unit at the central computer with the assigned processor, the assigned connection lines to the coupling network as well as to the message distribution system. Bringing several such units together to form a larger unit with a common processor core, for the purpose of saving space and costs, therefore results in significant software changes, and this is cost-intensive in view of the amount of programs to be ported, and therefore problematic. Extensive internal interface changes and changes in the user interface of the switching system, as well as in prior/supporting tools of manufacturers and network operators are connected with this.

The invention is based on the task of indicating a device by means of which the number of subscriber and/or trunk connections in a hardware platform for peripheral devices can be increased, while, at the same time, the peripheral devices continue to be maintained as the structure characterized by the previous peripheral device limitations.

The invention is accomplished, proceeding from the preamble of claim 1, by means of the characteristics indicated in the characterizing part.

It is particularly advantageous about the invention that the need for greater and more complex changes in the software of the switching center is eliminated. The savings in costs and space that can be achieved are furthermore greater than those that can be achieved by providing small, highly software-relevant hardware structures, each with its own control and with the same hardware technology. According to the invention, the individual control units are replaced by a single central hardware control for several hardware structures, specifically in such a way that the switching center software continues to see and operate the small hardware structures.

For this purpose, the configuration used in the state of the art for controls not directly linked to hardware is expanded to hardware-related controls. The resulting peripheral devices of a virtual nature possess a hardware reference and are connected with the coupling network of the switching center via their own physical interfaces. In the direction of the message distribution system, they possess their own logical interface that is expressed by the virtual peripheral device having its own address in the switching system.

A hardware platform for a plurality of peripheral devices can have a plurality of physical connections with the internal message distribution system, each of which contains at least one logical interface of a peripheral device of a virtual nature.

Advantageous further developments of the invention are indicated in the dependent claims.

The invention is explained in greater detail below, on the basis of an exemplary embodiment shown in the drawings.

These show:

FIG. 1 The architecture of a classical peripheral device according to the state of the art;

FIG. 2 The architecture of the device on the basis of two peripheral bundles of access lines, controlled by a processor.

The configuration described in the European patent application EP 99123208.3, according to which the operating system running on the peripheral device and the hardware-related back-up technology programs of the peripheral device are changed in such a way that they support the support of n virtual peripheral devices that are active on the same hardware processor basis (for example, by means of a generalized task switch), is used for a peripheral device that comprises n (e.g., two) real peripheral devices known to the switching technology software but only one common processor or memory, and one or more physical interfaces to the message distribution system. The relationships in this regard are shown in FIG. 2.

The central program for the distribution of messages that reach a real, existing peripheral device, on which virtually existing peripheral devices without reference to the hardware peripherals are implemented, therefore remains unchanged if, instead of the virtual peripheral devices, real peripheral devices with a hardware reference are now controlled by the central device. If several physical message interfaces at the common processor control for several peripheral devices exist, the distribution algorithm must be adapted. The n peripheral devices controlled by the same physical processor core utilize the same interface to the message distribution system. Assignment of the peripheral devices to the central processor core takes place administratively.

If more than one peripheral device of a processor control active for a plurality of peripheral devices utilizes the same physical message channel, the message distribution system is adapted in such a way that it supports the addressing of different logical peripheral devices by way of the same message channel. This means that the message distribution system finds the physical message channel to the central processor, by way of which the output is to occur, on the basis of the logical address of the peripheral devices. In order to be able to deliver the message in the peripheral device to the correct virtual peripheral device, the logical target address is transmitted as part of the message header and used in the aforementioned central program part of the peripheral device for further distribution to the addressed virtual peripheral device. If each of the peripheral devices under a common processor control possesses its own physical interface to the message distribution system, the message distribution system remains unchanged.

The back-up technology of the peripheral device with virtual parts is adapted in such a way that the failure or the renewed availability of a peripheral device becomes particularly simple:

If a hardware component relevant for all peripheral devices under a common processor control fails, this will result in the failure of all the peripheral devices that run on this device. If the hardware goes back into operation after the software is reloaded, or after repair, this will result in renewed availability of the functions of the related peripheral devices. For reasons of simplicity, the temporary failure of a virtual peripheral device brought about by software errors can also be represented as the temporary non-availability of all peripheral devices running on the assigned peripheral device (this means that in the simplest case, a program defect recognized and reported by a virtual peripheral device will result in the entire peripheral device being taken out of operation and automatically put into operation again after reloading of the peripheral device).

The loading program for loading program and data portions of background memory into the peripheral device is adapted in such a way that selective loading of all data of the virtual peripheral devices assigned to a central processor core is made possible by way of at least one physical channel. If the program of all the peripheral devices on a physical peripheral device is identical, multiple loading of the same program can be eliminated for the sake of optimization.

The number of peripheral devices that can run on a hardware platform for peripheral devices is determined by the performance of the processors used in the peripheral device, the memory size and the performance capacity of the message interface to the remainder of the system, as well as the space requirement for the hardware required for specific equipment. In particular, if the interface to the message distribution system does not have sufficient performance capacity, additional message paths between peripheral devices and other devices of the switching system can be switched, thereby relieving, i.e., circumventing the message distribution system.

The hardware structure of the peripheral devices, particularly the number of voice channels terminated by a device, has a strong influence on the structure of the switching-related database and the processing software. By increasing the performance capacity of the processors and the memory density, and by reducing the size of the dimensions of the hardware terminating the voice channels, it is possible to terminate many times the voice channels in a hardware platform for peripheral devices in the same space as is possible with available peripheral devices with the same dimensions.

The configuration shown can serve to make such compression largely invisible for the user software running on the system and the user interface, in that several peripheral devices with the previous structure and number of voice channels are seen and made available as an interface on a hardware platform for peripheral devices that possesses greater hardware resources and a central processor control.

In modern communications systems, a peripheral unit LTG currently terminates four PCM30 segments and is implemented on one card. The required control tasks are handled by one processor in this LTG device. The increased performance capacity of the processors and the compression of the area of the hardware make it possible to control a larger number of connections, per card, by one processor. However, the hardware assignment that exists today is firmly anchored in the software of the switching system (e.g., the coordinating control processor) and can only be changed at great effort and expense.

By using the invention, it is possible to double the number of connections per card, with the software of the switching center continuing to see small devices, and therefore only having to be changed slightly. The resulting virtual peripheral devices with hardware reference are connected to the coupling network by way of their own physical connections, and possess their own logical addresses within the internal message distribution system.

1. Device for processing connections conducted by means of a switching system and assigned to a plurality of peripheral devices, each of the peripheral devices (LTG) having interfaces to each device within the system and outside the system assigned to them,
characterized in that
each of the peripheral devices has its own logical interface to the message distribution system within the switching system,
that a processor control common to the plurality of peripheral devices is provided, which processes the tasks of each of the peripheral devices, contained in the plurality, in the same manner as this is done by separate processor controls present per peripheral device.

2. The device according to claim 1,
characterized in that
per peripheral device, a fixed or administerable number of PCM/SDH segments is terminated to prior concentrators, extensions or remote switching systems.

3. The device according to claims 1 and 2,
characterized in that
per common processor control, a fixed or administerable number of peripheral devices is controlled as a function of the hardware structure of the platform, the call model, the processor output, the performance of the message interface and the memory structure.

4. The device according to claim 1,
characterized in that
per peripheral device of a common processor control, the logical interface to the message distribution system is contained in a message channel that is utilized exclusively or by several peripheral devices of the common processor control.

5. The device according to claims 1 to 4,
characterized in that
loading of the peripheral devices by the common processor control is supported by means of the assigned logical interface to the message distribution system.

6. The device according to one of the preceding claims,
characterized in that
the failure or renewed availability of the common processor control or of central hardware components causes the failure or renewed availability of all assigned peripheral devices.

7. The device according to one of the preceding claims,
characterized in that
use on undoubted and doubled hardware platforms for peripheral devices is carried out, whereby in the latter case, doubled common processor platforms for virtual peripheral devices with a hardware reference are formed.

8. The device according to one of the preceding claims,
characterized in that
stable connections for hardware platforms for peripheral devices designed in a double manner are rescued in that concurrent updating of switching technology data storage and statuses is carried out on the redundant unit per updating channel (synchronization channel) present logically or physically in the peripheral device.

9. The device according to one of the preceding claims,
characterized in that the common processor control for the plurality of peripheral devices itself consists of a plurality of processors, with its own program and data memory and its own physical interface to the switching technology message distribution system.

10. The device according to one of the preceding claims,
characterized in that
the devices outside the system are structured as connected subscribers, extensions, prior subscriber concentrators and/or remote switching systems.

11. The device according to one of the preceding claims,
characterized in that
the plurality of peripheral devices of the device utilize specific hardware for interfaces to devices outside the system, utilize specific hardware for interfaces to the coupling network of the switching system, or utilize hardware assigned to other switching technology tasks of the device, such as tone generators, DTMF receivers or signaling protocol termination.
